(19) United States
(12) Patent Application Publication
(10) Pub. No.: US 2016/0098942 A1
(43) Pub. Date: Apr. 7, 2016

(54) Method for Generating Low-Waste Personalized Meal Plans within a Budget

(71) Applicant: Richard Thomas Messier, Fairfax, VA (US)

(72) Inventor: Richard Thomas Messier, Fairfax, VA (US)

(21) Appl. No.: 14/504,216

(22) Filed: Oct. 1, 2014

(51) Int. Cl. G09B 19/00; G09B 5/00

(52) U.S. Cl. CPC G09B 19/0092; G09B 5/00

(57) ABSTRACT

Disclosed is a method for generating a meal plan including receiving a plurality of user profiles, receiving a cuisine selection, receiving a budget selection, displaying a meal plan in accordance with the cuisine selection and the budget selection, the meal plan including a plurality of meals wherein at least one of the plurality of meals is scaled in accordance with the plurality of user profiles, displaying a first cost associated with the meal plan, displaying a shopping list in accordance with the meal plan, the shopping list including a plurality of ingredients associated with the plurality of meals.

### BACKGROUND OF THE INVENTION

1. Field of the Invention

The embodiments of the invention relate a method for generating a meal plan, and more particularly, to a method for generating a portion-controlled, meal plan for a group of people while minimizing waste. Although embodiments of the invention are suitable for a wide scope of applications, it is particularly suitable for generating a weekly meal plan for a family while minimizing costs and waste.

2. Discussion of the Related Art

Current solutions for generating a weekly meal plan while minimizing costs and waste are generally limited to mental processes and recipe-picker software. In the related art, a meal planner may plan a plurality of meals for a limited time period (i.e. a week). The meal planner would then travel to a preferred grocer and purchase the ingredients necessary to prepare the meals. The related art recipe-picker software provides a variety of recipes and can compile a grocery list including the ingredients needed to prepare selected recipes.

There are however many drawbacks and limitations to the related art. Mental manipulation of a meal plan to minimize cost and waste while meeting dietary restrictions is a challenging and inefficient exercise in mental gymnastics. For example, many ingredients are sold in containers having a fixed size and many recipes call for only a portion of the fixed-size container. In these cases, the remaining portion of the fixed-sized container may be wasted due to spoliation. In the related art, it can be challenging for a meal planner to scale a large number of meals in accordance with the anticipated guests. It can be further challenging to scale meals while minimizing food waste.

The related art methods of minimizing cost are limited too. If a meal planner desires to learn the price of a food item, the meal planner is generally limited to researching weekly advertising circulars in print and online or physically inspecting the prices on store shelves. Many grocery store websites do not provide individualized pricing for every item in the store. Thus, when a meal planner desires to prepare an economic meal using the lowest-cost combination of ingredients, the meal planner incurs significant transaction costs researching and comparing limited published information and additional transaction costs physically checking prices in stores.

In the related art meal planning it is challenging to meet the dietary restrictions of all guests who may have allergies or dislikes that are cumbersome to track and accommodate. The related art meal planning has limited ability to account for portion variation in accordance with a guest's desired caloric intake for a particular meal, or a particular day.

The related art meal planning is limited to the mental faculties and available research sources for choosing meals for a meal plan. Unsophisticated or lazy meal planners may lack diversity in their meal plan and may duplicate a limited set of known meals into perpetuity.

### SUMMARY OF THE INVENTION

Accordingly, embodiments of the invention are directed to a method for generating low-waste personalized meal plans within a budget that substantially obviates one or more of the problems due to limitations and disadvantages of the related art.

An object of embodiments of the invention is to provide a method for generating a meal plan that minimizes wastage.

Another object of embodiments of the invention is to provide a method for generating a meal plan that accommodates allergies and dislikes.

Yet another object of embodiments of the invention is to provide a method for generating a meal plan that minimizes costs.

Still another object of embodiments of the invention is to provide a meal plan having a variety of meals within a particular theme or cuisine.

Another object of embodiments of the invention is to provide a method of apportioning a preferred daily caloric intake between two or more meals.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, method for generating low-waste personalized meal plans within a budget includes receiving a plurality of user profiles, receiving a cuisine selection, receiving a budget selection, displaying a meal plan in accordance with the cuisine selection and the budget selection, the meal plan including a plurality of meals wherein at least one of the plurality of meals is scaled in accordance with the plurality of user profiles, displaying a first cost associated with the meal plan, and displaying a shopping list in accordance with the meal plan, the shopping list including a plurality of ingredients associated with the plurality of meals.

In another aspect, method for generating low-waste personalized meal plans within a budget includes receiving a plurality of user profiles, each of the plurality of user profiles including a meal participant name and a daily caloric intake selection, receiving a cuisine selection, receiving a location information, receiving a budget selection, displaying a meal plan in accordance with the cuisine selection and the budget selection, the meal plan including a plurality of meals wherein at least one of the plurality of meals is scaled in accordance with the plurality of user profiles, displaying a first cost associated with the meal plan, the first cost based on a price a plurality of ingredients associated with the plurality of meals at a first grocery store, and displaying a shopping list in accordance with the meal plan, the shopping list including the plurality of ingredients associated with the plurality of meals.

In yet another aspect, method for generating low-waste personalized meal plans within a budget includes receiving a plurality of user profiles, each of the plurality of user profiles including a meal participant name, a daily caloric intake selection, an activity level selection, and a list of allergens, receiving a cuisine selection, receiving a zip code, receiving a budget selection, receiving a selection of one or more days, assigning one or more user profiles of the plurality of user profiles to each of a breakfast meal, a lunch meal, and a dinner meal on each of the one or more days, displaying a meal plan for the one or more days, the meal plan displayed in accordance with the cuisine selection and the budget selection and scaled in accordance with the one or more user profiles assigned to the breakfast meal, the lunch meal, and the dinner meal on each of the one or more days, displaying a first cost associated with the meal plan, the first cost based on a price a plurality of ingredients associated with the plurality of meals at a first grocery store, displaying a shopping list in accordance with the meal plan, the shopping list including the plurality of ingredients associated with the plurality of meals, and receiving a rating for at least one dish of one of the plurality of meals.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a flow chart showing a method for generating a meal plan according to an exemplary embodiment of the invention;

FIG. 2 is an exemplary input and display screen for a user profile according to an exemplary embodiment of the invention;

FIG. 3 is an exemplary input and display screen for a group profile according to an exemplary embodiment of the invention;

FIG. 4 is an exemplary input and display screen for a snack budget selection, cuisine selection, and day selection according to an exemplary embodiment of the invention;

FIG. 5 is an exemplary input and display screen for a meal plan participants according to an exemplary embodiment of the invention;

FIG. 6 is an exemplary input and display screen for staple and carry-over ingredients according to an exemplary embodiment of the invention;

FIG. 7 is an exemplary input and display screen for snack food and non-grocery items according to an exemplary embodiment of the invention;

FIG. 8A is an exemplary input and display screen for a meal plan according to an exemplary embodiment of the invention;

FIG. 8B is an exemplary input and display screen for a meal plan according to an exemplary embodiment of the invention;

FIG. 9 is an exemplary input and display screen for a grocery provider according to an exemplary embodiment of the invention; and

FIG. 10 is an exemplary results and display screen for a completed meal plan according to an exemplary embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

A variety of terminology is utilized herein and the following definitions are provided for clarity:

Meal Plan—A plan or schedule to prepare and serve certain meals over a period of time.

Meal—A group of one or more dishes to be served at a sitting such as breakfast, lunch, or dinner.

Dish—A single food (e.g. banana) or combination of ingredients (e.g. fruit salad).

Ingredient—A component of a dish.

Recipe—Instructions for preparing or combining ingredients to create a dish.

Meal Participant—A person planned to consume a meal.

User Profile—Information specific to a meal participant (e.g. allergies, dislikes, daily calories.)

Group Profile—Information specific to a group of meal participants (e.g. budget, zip code.)

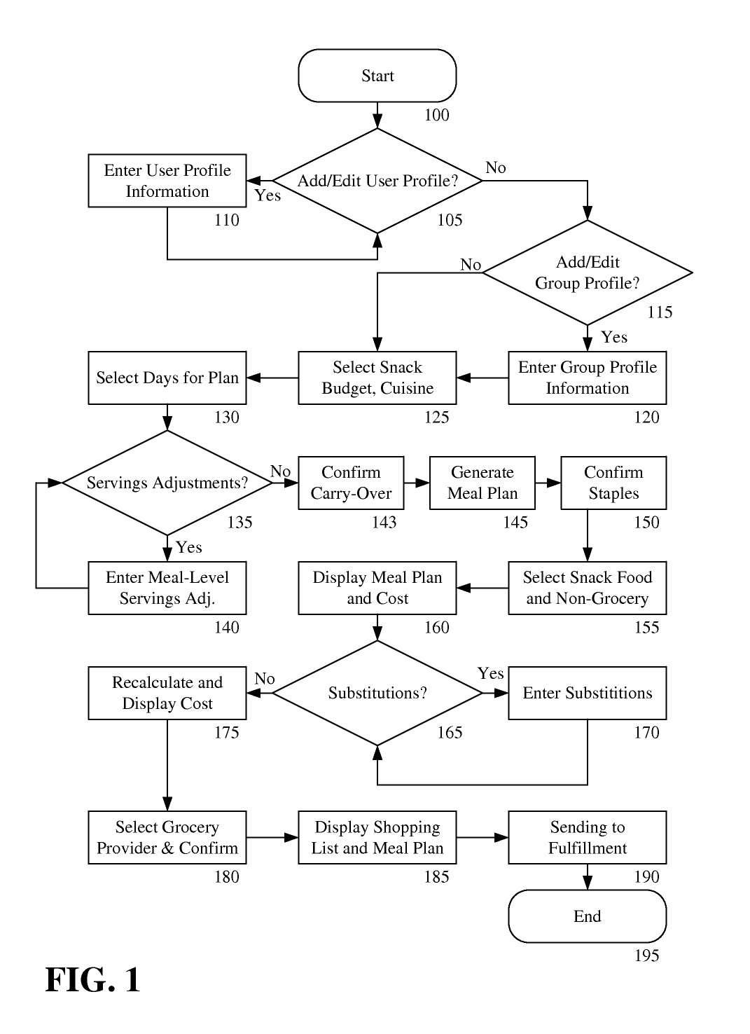

FIG. 1 is a flow chart showing a method for generating a meal plan according to an exemplary embodiment of the invention. As shown in FIG. 1, a method for generating a meal plan can include entering one or more user profiles 110, entering a group profile 120, selecting a snack budget and cuisine 125, selecting a day or days for the meal plan 130, adjusting the number of servings for a meal 140, confirming carry-over 143 foods, generating the meal plan 145, confirming staple foods 150, selecting snack foods and non-grocery items 155, displaying a meal plan and cost 160, entering substitutions for the meal plan 170, recalculating and displaying a cost for the meal plan 175, selecting a grocery provider and confirming 180, displaying a shopping list and meal plan 185, and sending the shopping list to fulfillment 190.

In preferred embodiments, the method for generating a meal plan is facilitated by computer software such as an app on a smartphone or portable computing device. In other embodiments, the method for generating a meal plan can be facilitated by a web page accessed through a web browser. In still other embodiments, the method for generating a meal plan can be facilitated by application software installed on a personal computer.

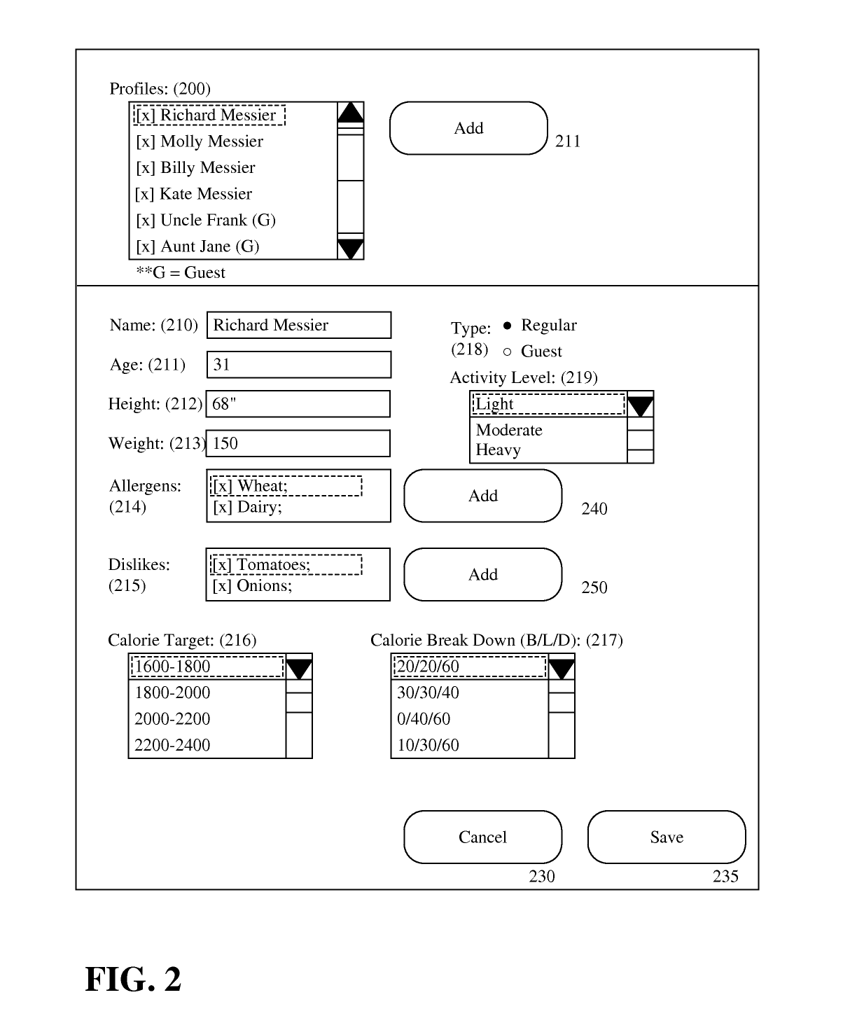

The method for generating a meal plan can begin at “start” step 100 and proceed to “Add/Edit User Profile” decision box 105. At this step 105, a user can chose whether to add additional user profiles or edit and existing user profile. If this is the first time the method is performed, it is unlikely that a user profile will exist and a user can decide “yes” and cause the software to proceed to the “enter user profile information” step 110. At step 110, and as will be described in great detail in conjunction with FIG. 2, the software can provide a list of user profiles and the option to add user profile. A user profile can contain information about a meal participant. A user can iteratively add new user profiles until all desired meal participants have been added. In the event profile information relating to a meal participant has changed, a user can similarly edit previously entered information such as to add dislikes or allergies to the user profile for a particular meal participant.

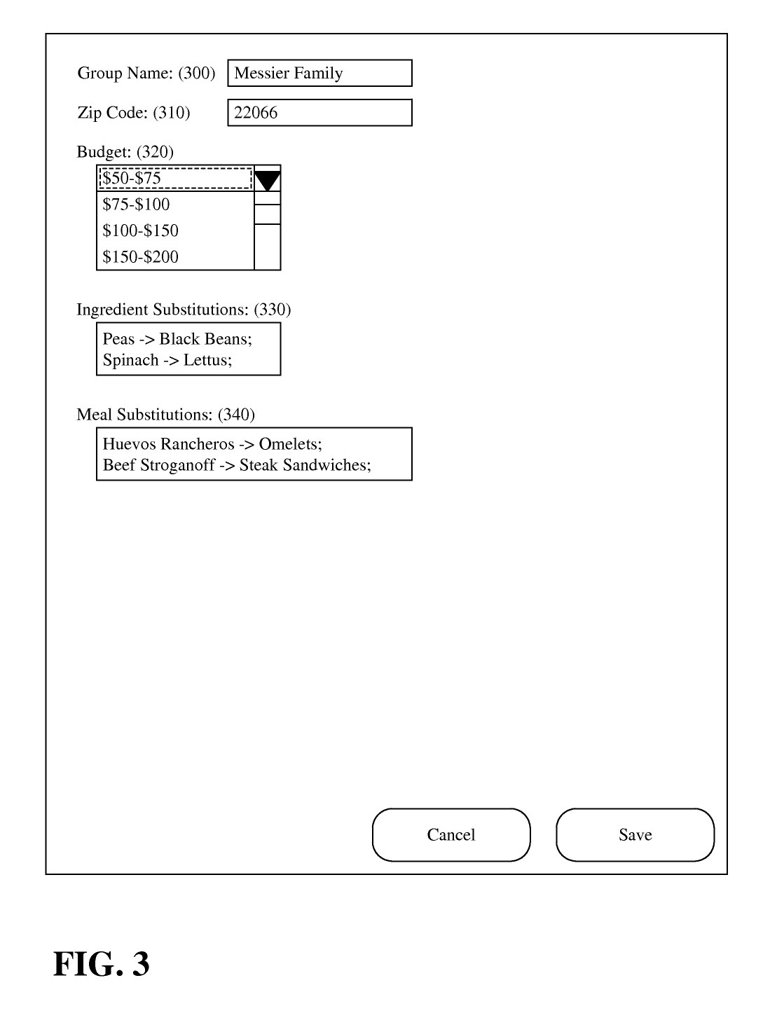

If at decision step 105 there are no user profiles to add or edit, the process flow can proceed to the Add/Edit Group Profile 115 decision box. At the Add/Edit Group Profile 115 decision step and as will be explained in greater detail in conjunction with FIG. 3, a user can chose to create a profile for a group of meal participants or edit an existing group profile. The group profile can contain information pertinent to a group of meal participants such as a location information, budget, or cuisine type. If at Add/Edit Group Profile 115 decision step, the user desires to enter group profile information, the process can transition to the Enter Group Profile Information Step 120 where in a user can enter or edit group profile information. If at Add/Edit Group Profile 115 decision step a user does not need to make changes to group profile information, or after a group profile has been added or updated in step 120, the process can transition to the Select Snack Budget and Cuisine step 125.

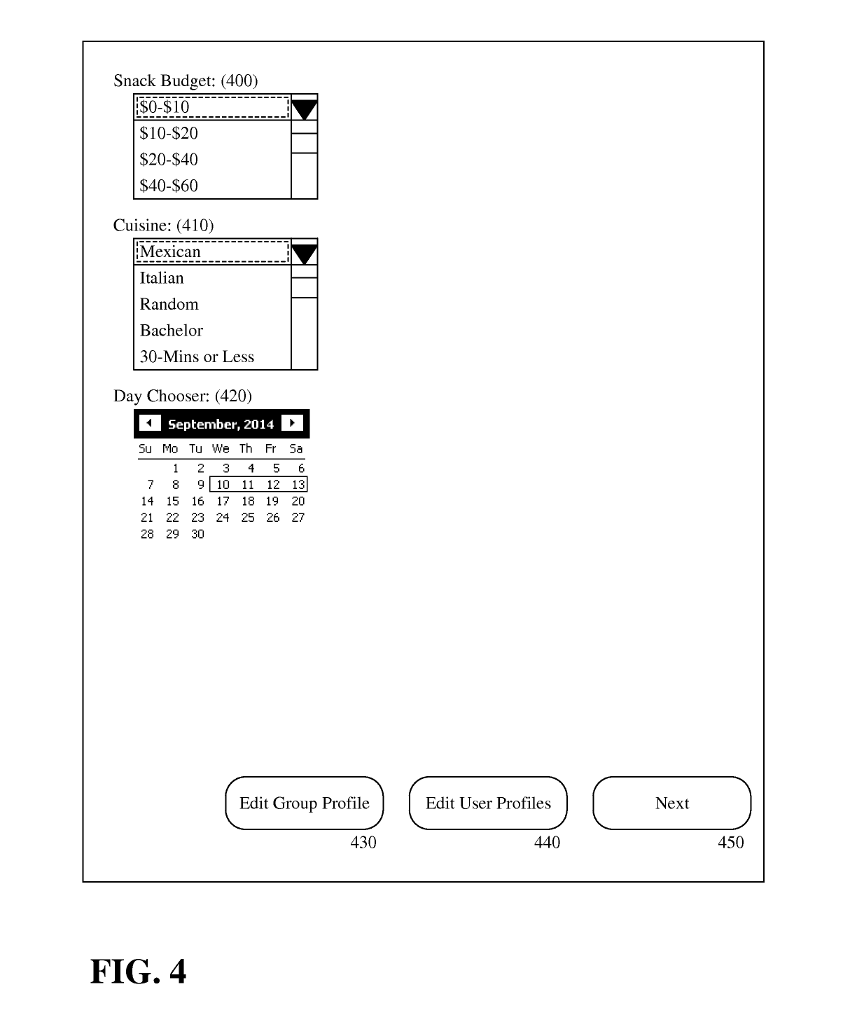

In the Select Snack Budget and Cuisine step 125 and as will be explained in greater detail in conjunction with FIG. 4, a user can select a budget for snack food items and select a cuisine type. After the Select Snack Budget and Cuisine step 125 the process can transition to the Select Days for Plan step 130. At the Select Days for Plan step 130, a user can select one or more days to be included in the meal plan. After the Select Days for Plan step 130, the process can transition to the Servings Adjustment decision step 135.

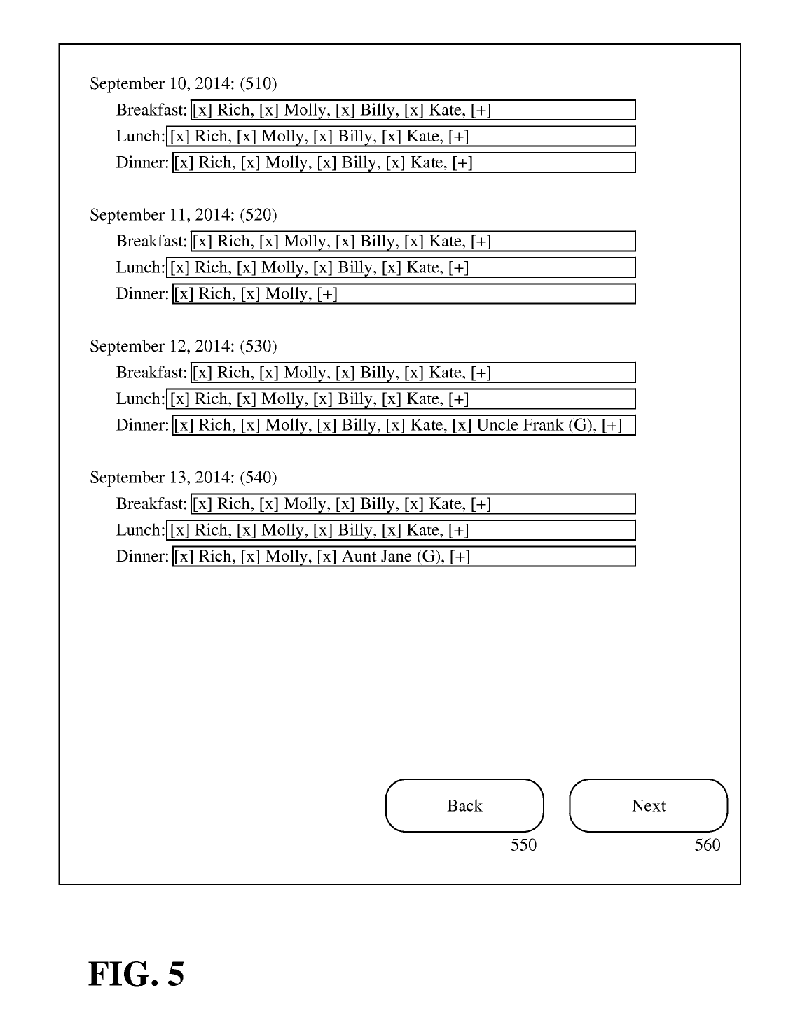

At the Servings Adjustment decision step 135 which will be explained in greater detail in conjunction with FIG. 5, a user can decide whether to adjust the number of servings for a particular meal on one of the days selected in the Select Days for Plan step 130. By default, a meal can be planned for each person for which there exists a user profile. For example, if there exists four user profiles and a meal plan covering two days, one serving can be planned for each profile, for each meal, for each day, such as four breakfast, lunch, and dinner servings for each of two days. If the user desires to adjust the number of servings, for example to account for the planned absence of a meal participant or the addition of a guest, the process can transition to Enter Meal-Level Servings Adjustment step 140.

At the Enter Meal-Level Servings Adjustment step 140, meal participants can be added and removed from the meal plan for each meal. After the Enter Meal-Level Servings Adjustment step 140 or in the even that no adjustments are necessary at Servings Adjustment decision step 135, the process can transition to the Confirm Carry-Over step 143.

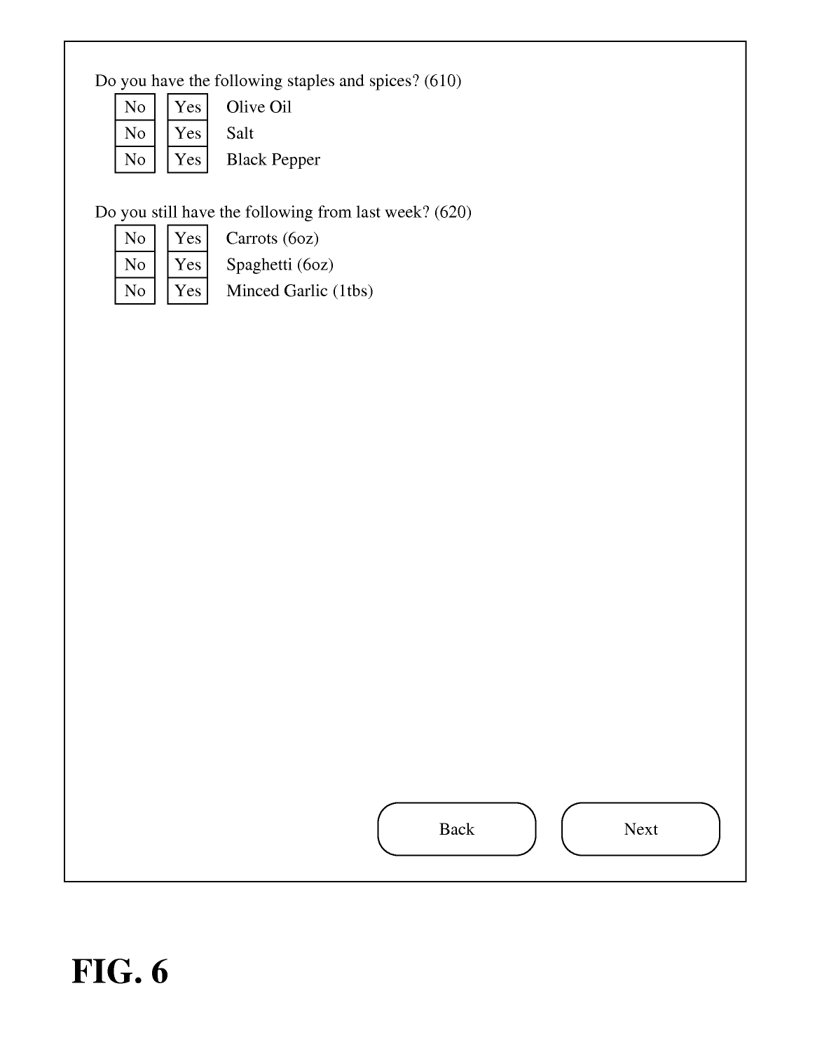

In the Confirm Carry-Over step 143 and as described in greater detail in conjunction with FIG. 6, the program can identify carry-over ingredients from a previous meal plan. Carry-over ingredients can be common foods that are purchased for a particular meal plan, but are sold in sufficiently large units that using the entire unit within a single meal plan is not feasible. These carry-over ingredients can include, for example, rice, beans, cereals, drinks, etc. In embodiments of the invention, the program can assume, by default, that the carry-over ingredients are “on-hand.” In other embodiments of the invention, the program can prompt a user to confirm that certain carry-over ingredients are in fact on hand.

In a more specific example, of confirming carry-over on-hand, an exemplary meal plan may specify eggs with breakfast, hummus with lunch, and bread with dinner. Because eggs are commonly sold in packages of 12, hummus in tubs, and bread in loafs, these ingredients may be on-hand from previous meal plans. In the Confirm Carry-Over step 143, a user can confirm that eggs, hummus, and bread are on-hand. Alternatively, the bread may have become moldy and discarded. In this case, a user can confirm the eggs and hummus are on hand, but not the bread. After the Confirm Carry-Over step 143, the process can transition to the Generate Meal Plan step 145.

At the Generate Meal Plan step 145, the software can generate a meal plan for the selected days and meal participants taking into consideration information in the group profile and each meal participant's user profile. The Generate Meal Plan step 145 can include selecting a plurality of meals from a database where each meal includes one or more dishes. The meals can be selected from the database at random, or can be generated in real time by grouping one or more dishes selected at random. A meal can be assigned to each of breakfast, lunch, and dinner for each day of the meal plan.

Each dish of a meal can be filtered according to the user profiles and the group profiles. For example, if a user profile includes an egg allergy, and a randomly selected dish includes eggs, the randomly selected dish can be discarded and a new dish can be selected at random.

Each meal can be scaled according to the default number of servings or the Meal Level Servings Adjustment from step 140. For example, if a single serving of a meal assigned to breakfast included one banana and two eggs, the meal can be scaled by a factor of four to accommodate four meal participants thus the meal would include four bananas and eight eggs.

Meal scaling can be further refined by a caloric profile for each meal participant. In preferred embodiments of the invention, each meal participant is associated with a preferred daily caloric input range. The preferred daily caloric input range can be, for example, 1400-1600 calories, 1600-1800 calories, 1800-2000 calories, etc. An adult meal participant can be associated with a larger preferred daily caloric input range than a child meal participant. For example, an eight-year-old child may have a preferred daily caloric input range of 1000-1200 while an adult may have a preferred daily caloric input range of 1800-2000.

The preferred daily caloric input range for each meal participant can be apportioned between each of three daily meals. For example, an adult having a preferred daily caloric input range of 1800-2000 calories can apportion those calories 30% to breakfast, 30% to lunch, and the remaining 40% to dinner (“30/40/40”). Apportionment of calories between meals can be an explicit user-entered apportionment such as the Calorie Break Down selection 217 of FIG. 2. In the alternative, the calorie apportionment can be determined programmatically, for example, by evaluating apportioning calories based upon the user's age, height, weight, and activity level in view of common dietary recommendations. For example, a school-aged child that is of average weight and having a high activity level can have more calories apportioned to breakfast and lunch than dinner, e.g. 40/40/20. In another example, an adult having above average weight and low activity level can have few calories apportioned to breakfast and lunch and more apportioned to dinner, e.g. 25/25/50.

In embodiments of the invention including meal scaling, a preferred daily caloric input range, and apportionment, generating the meal plan can further include calculating, for each meal participant, a calorie range for each meal. The calculation can further include summing, for a given meal, the calorie range of each meal participant to obtain an aggregate calorie range for the meal. The dishes of the meal can then be scaled according to the aggregate calorie range for the meal. For example, in breakfast meal including the dish of one banana and the dish of two eggs, if the aggregate calorie range for a breakfast meal for four people is 1000-1200 calories, the total number of bananas and eggs in the meal can be scaled to fall within the range of 1000-1200 calories. If a banana is 105 calories and an egg is 80 calories, the example scaled breakfast meal for four meal participants can include four bananas and eight eggs for a total of 1060 calories.

In a second example, if the aggregate calorie range for a breakfast meal for four people is instead 800-1000, the same meal can be scaled by a factor of 3.5 to achieve a total of 927.5 calories. In embodiments of the invention, the resulting meal would include 3.5 bananas and 7 eggs. Although this embodiment technically meets the desired calorie range, the result is somewhat disadvantageous in that bananas do not come in half-units thus 4 bananas would be required and, because bananas do not keep well, the unused half-unit could be wasted. In other embodiments of the invention, fractional units, such as the half banana, are rounded up or down so that the meal includes only whole units of certain ingredients that are difficult or wasteful to divide (e.g. fruits.) Thus the resulting meal in these other embodiments of the invention includes 4 bananas and 7 eggs for a total of 980 calories.

In embodiments of the invention including the Confirm Carry-Over step 143, the Generate Meal Plan step 145 can include searching for and selecting meals and dishes that utilize one or more of the carry-over ingredients identified in step 143. The amount of an ingredient to be purchased to prepare a dish can be reduced by the amount of carry-over identified in the Confirm Carry-Over step 143. Using carry-over ingredients can reduce cost and waste.

In embodiments of the invention, the Generate Meal Plan step 145 can further select meals and dishes based upon a recommended nutritional profile. The recommended nutritional profile can be, for example, based upon recommended dietary allowances promulgated by the U.S. National Institutes of Health or the U.S. food and drug administration. The recommended nutritional profile can specify, for example, a daily portion of proteins, fats, sugars, and carbohydrates. The Generate Meal Plan step 145 can, for a particular day, select meals and dishes that meet the recommended nutritional profile.

In still further embodiments of the invention, partial left-over portions of ingredients can be tracked and used in other meals in the meal plan. For example, if a dish of a first meal includes half of a tomato for an ingredient, the Generating a Meal Plan step 145 can include searching for a second meal that, when scaled to the number of meal participants, would use the other half of the tomato. The second meal can be scheduled temporally close to the first meal to minimize the likelihood of wastage thereby reducing costs. In a more specific example, if a first half tomato of a tomato is used in a taco dinner meal, the Generating a Meal Plan step 145 can include planning a salad lunch meal the following day to use the second half of the tomato.

After the Generating a Meal Plan step 145, the process can transition to the Confirm Staples step 150. In the Confirm Staples step 150 and as described in greater detail in conjunction with FIG. 6, the program can identify staple ingredients included in the meal plan. A staple ingredient can be, for example, an oil, a vinegar, salt, sugar, etc. Staple ingredients are commonly sold in large quantities and used in small, sometimes imprecise quantities that are difficult to programmatically determine the amount on-hand. In embodiments of the invention, the program can assume, by default, that the staple ingredients are “on-hand” and exclude those ingredients from a shopping list. In other embodiments of the invention, the program can prompt a user to confirm that certain staple ingredients are in fact on hand.

In a more specific example, of confirming staples and carry-over on-hand, an exemplary meal plan may specify olive oil as an ingredient of a dish. Because olive oil is sold in large quantities relative to the amount commonly used, it is likely that a user has olive oil on-hand if it was purchased in the past. In the Confirm Staples step 150, a user can confirm that olive oil is on-hand and the program can remove these items from a shopping list for the generated meal plan. Alternatively, the olive oil may have become rancid or consumed. In this case, a user can confirm that olive is not on-hand and thus should be included on a shopping list for the generated meal plan. After the Confirm Staples step 150, the process can transition to the Select Snack Food and Non-Grocery step 155.

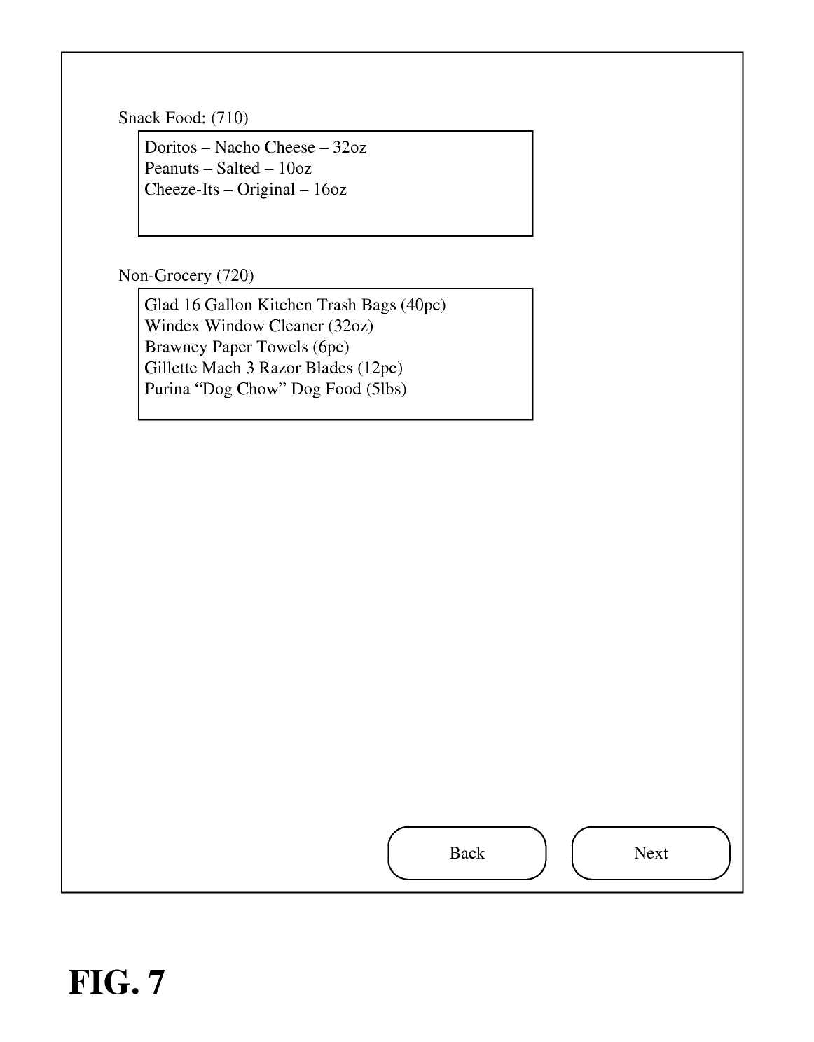

In the Select Snack Food and Non-Grocery step 155 and as described in greater detail in conjunction with FIG. 7, a user can be presented with a list of snack food and list of non-grocery items. The user can select from the list of snack food and non-grocery items products that can be added to the shopping list. Snack food can include, for example, potato chips, salty foods, crackers, pretzels, ect. Non-grocery items can be non-food items commonly found in stores such as trash bags, shampoo, cleaners, and personal care products. After the Select Snack Food and Non-Grocery step 155 the process can transition to the Display Meal Plan and Cost step 160.

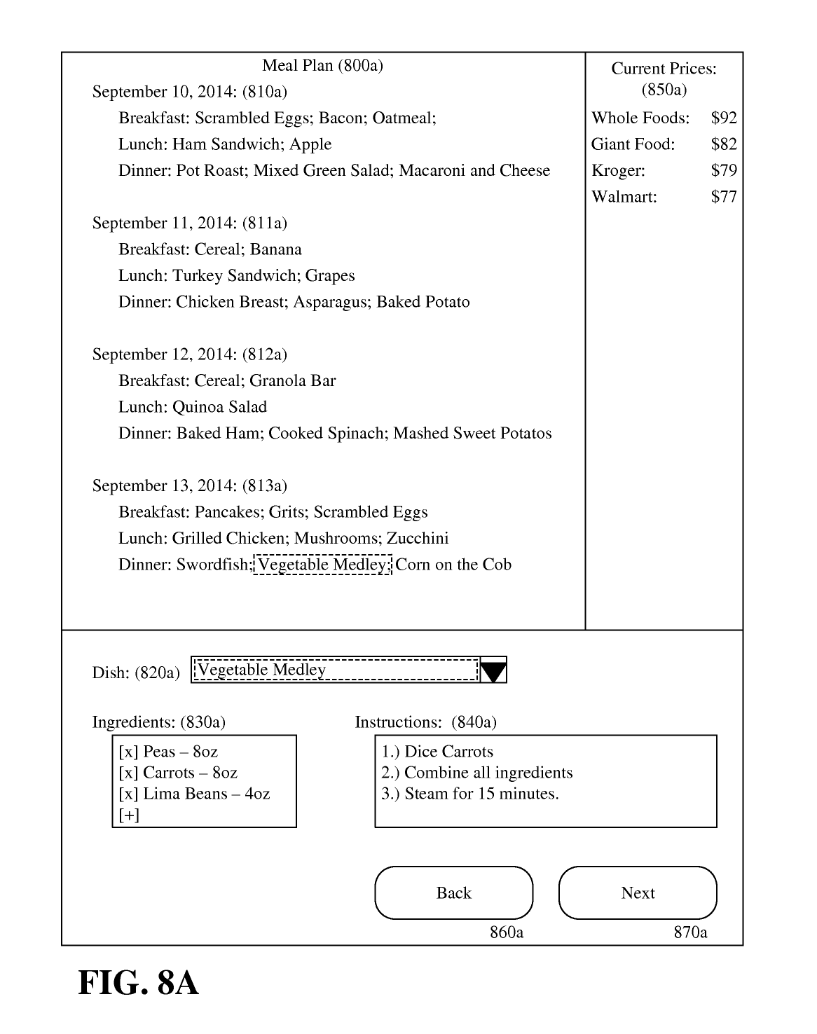

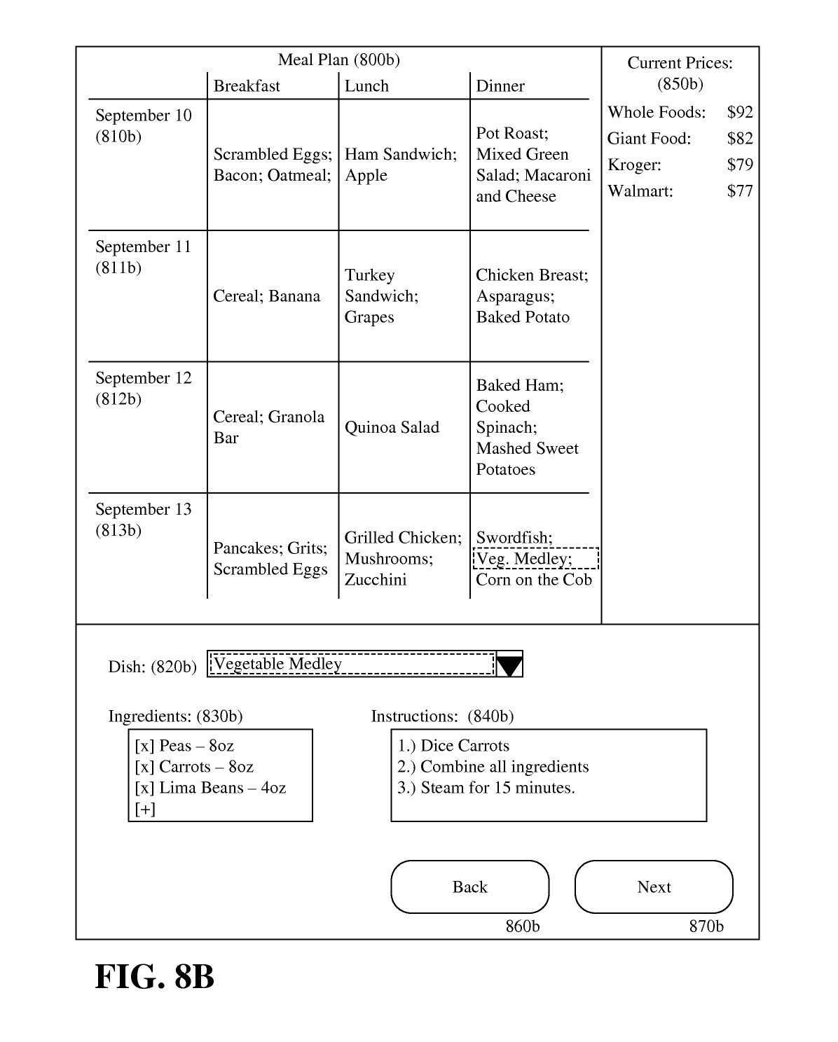

In the Display Meal Plan and Cost step 160 and as described in more detail in conjunction with FIG. 8A and FIG. 8B, the program can present the user with a list of days, the meals planned for those days, and the cost of the meal plan at various grocery stores. A user can select individual dishes of the meals to view the ingredients and instructions for preparing the dishes.

The cost displayed can be cost to purchase the ingredients of the meal plan at a particular grocery store that is proximate to the location information provided in the group profile. In embodiments of the invention, the cost information can be downloaded from databases of particular grocery store chains to a database controlled by the software provider. The cost information can include adjustments for store specials, available coupons, and discounts. The program can pull cost information from the software provider's database. In other embodiments of the invention, the program can download cost information directly from a grocery store database. In a more specific example, the software provider can have an arrangement with Wal-Mart grocery to access and download price and product information directly from Wal-Mart servers. The price and product information can be stored in a database controlled by the software provider. When a user generates a meal plan with the program, the program can download cost information for each of the ingredients from the software provider's server to calculate a total cost of the meal plan.

After the Display Meal Plan and Cost step 160, the process can proceed to the Substitution decision step 165 and if the user desires to make substitutions, the process can proceed to the Enter Substitutions step 170. In the Enter Substitutions step, the user can substitute meals or substitute ingredients for meals according to their preference. The process can flow between decision step 165 and Enter Substitution step 170 until all substitutions have been entered. After all substitutions have been made, the process can transition from Substitution decision step 165 to Recalculate and Display Cost step 175.

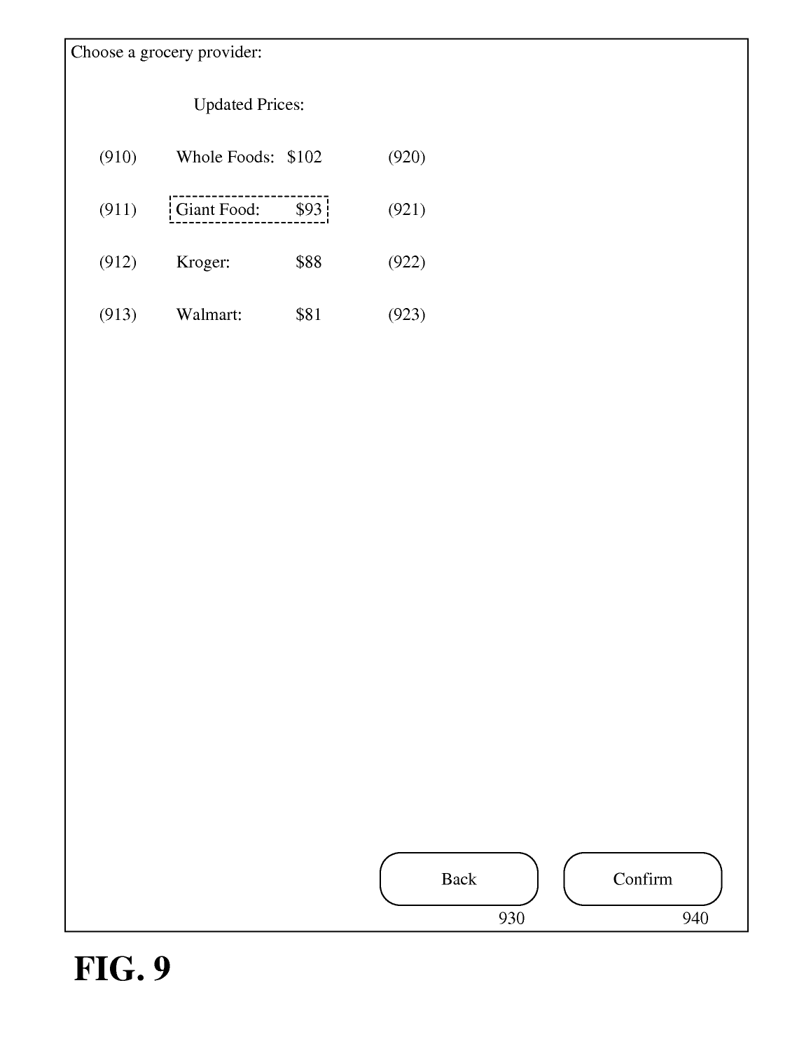

In Recalculate and Display Cost step 175 and as described in more detail in conjunction with FIG. 9, the cost of the meal plan is recalculated to account for any substitutions that were made in Enter Substitution step 170. In the Select Grocery Provider and Confirm step 180, the user can select one of the grocery providers and finalize the meal plan. After the Select Grocery Provider and Confirm step 180 the process can transition to the Display Shopping List and Meal Plan step 185.

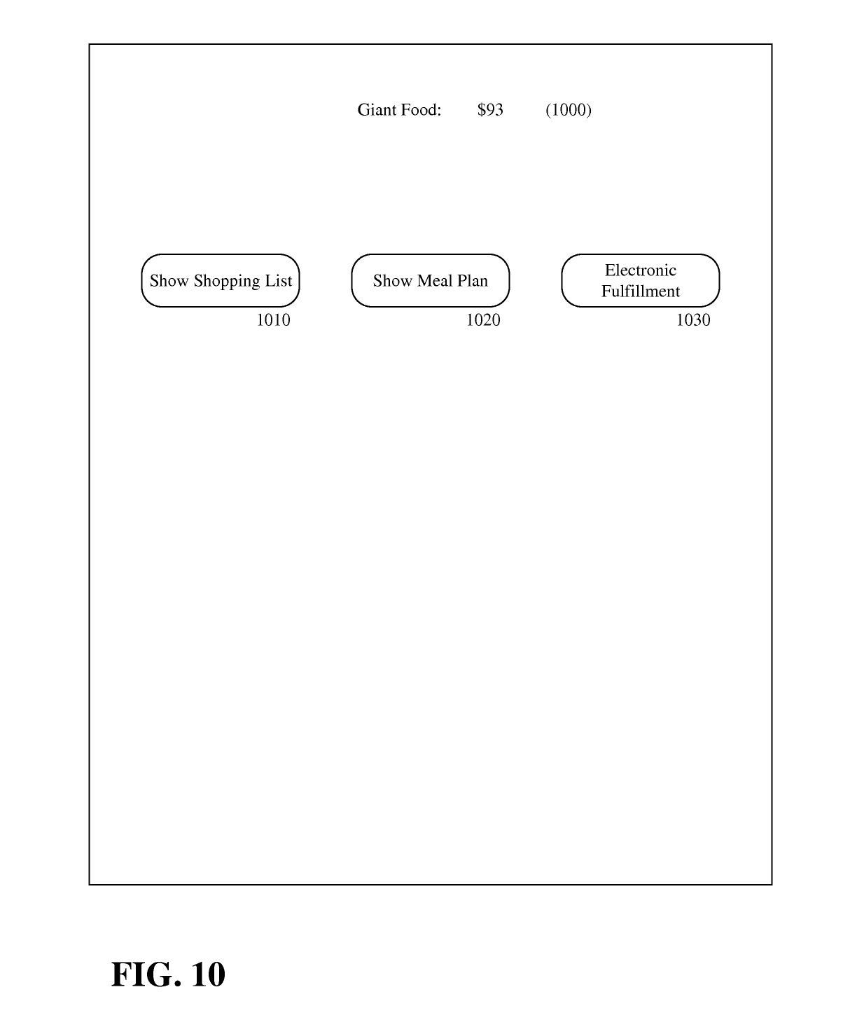

In the Display Shopping List and Meal Plan step 185 and as described in more detail in conjunction with FIG. 10, the program can display options for displaying the shopping list, the meal plan, or sending the shopping list to electronic fulfillment. Displaying the shopping list can display a list of the ingredients needed to make the dishes the comprise the meal plan. The shopping list can exclude the on-hand staple ingredients and identified on-hand carry-over ingredients identified in Confirm Carry-Over step 143 and the Confirm Staples step 150. The shopping list can include snack food items and non-grocery items selected in Select Snack Food and Non-Grocery step 155. Displaying the meal plan can include displaying a meal plan as shown in FIG. 8A or FIG. 8B. Sending a shopping list to electronic fulfillment can include electronically sending the shopping list to a grocery provider such as through the Internet. The electronic fulfillment center can collect the items on the shopping list and prepare them for easy pick up by the user. The electronic fulfillment center can collect the items on the shopping list and deliver them directly to the user, such as through Giant's Peapod service.

FIG. 2 is an exemplary input and display screen for a user profile according to an exemplary embodiment of the invention. As shown in FIG. 2, an exemplary input and display screen for a user profile includes a list of profiles 200, a meal participant name 210, a meal participant age 211, height 212, and weight 213, a list of allergens 214, a list of dislikes 215, a daily calorie target selection 216, a calorie apportionment selection 217, a type selection 218, and an activity level selection 219.

The exemplary input and display screen for a user profile can be used to display existing user profiles, edit existing user profiles, or add new user profiles. The list of profiles 200 includes six exemplary profiles for meal participants. The user profile for meal participant “Richard Messier” is in a selected state as indicated by the dotted box surrounding the text “Richard Messier.” A user profile can be added or deleted. In this example a user profile can be deleted by selecting the [x] next to the name of a user profile and a user profile can be added by selecting the Add button 211.

When a user profile is selected, information pertaining to the user profile is populated in the meal participant name 210, the meal participant age 211, height 212, and weight 213, the list of allergens 214, the list of dislikes 215, the daily calorie target selection 216, the calorie apportionment selection 217, the type selection 218, and the activity level selection 219. When a user profile is selected, information in the foregoing fields can be edited by selecting the desired field and changing the information using an input device such as a keyboard, mouse, or touch sensor. Edited information can be saved by selecting the save button 235. Changes to information can be aborted by selecting the cancel button 230.

The meal participant name 210 can be the name of meal participant and can also be used as an identifier for a user profile. The meal participant age 211 can be the age of the meal participant. The meal participant height 212 can be the height of the meal participant. The meal participant weight 213 can be the weight of the meal participant. In embodiments of the invention, the age, weight, and height can be optional entries and, if provided, can be used to calculate the health of the meal participant. In other embodiments of the invention, the meal participant age, weight, and height can be used to recommend a daily calorie target selection 216 and the calorie apportionment selection 217.

The list of allergens 214 can include a list of food items or food types that the meal participant is allergic to. In the example illustrated in FIG. 2, meal participant Richard Messier is allergic to wheat and dairy. In embodiments of the invention, the Generate Meal Plan step 145 of FIG. 1 can include excluding a dish that includes ingredients on the list of allergens 214 for a particular meal participant. In other embodiments of the invention, the Display Meal Plan and Cost step 160 of FIG. 1 can include marking or identifying dishes that include allergens.

The list of dislikes 215 can include a list of food items or food types that the meal participant does not prefer. In the example illustrated in FIG. 2, meal participant Richard Messier does not like tomatoes or onions. In embodiments of the invention, the Generate Meal Plan step 145 of FIG. 1 can include excluding a dish that includes ingredients on the list of dislikes 215 for a particular meal participant. In other embodiments of the invention, the Display Meal Plan and Cost step 160 of FIG. 1 can include marking or identifying dishes that include ingredients on the list of dislikes.

Each of the list of allergens 214 and list of dislikes 215 can be manipulated in similar fashion. Items can be removed the list by selecting the [x] to the left of the item. Items can added by selecting the Add button 240 or 250 to the right of the respective list 214 or 215. Upon selecting the Add button 240 or 250 a new blank row (not shown) can be added to the respective list 214 or 215. The new blank row can be user-fillable with the allergen or dislike to be added. The user-fillable new blank row can be cross-referenced with a dictionary of ingredients and ingredient types and the program can offer auto-complete suggestions for ingredients as the user is typing.

The daily calorie target selection 216 can include one or more calorie ranges. In embodiments of the invention, the Generate Meal Plan step 145 of FIG. 1 can scale the meals for a day such that the total calories is within the range specified in the daily calorie target selection 216. If, for example, there are many meal participants, the daily calorie target selection 216 of each meal participant can be summed and the Generate Meal Plan step 145 of FIG. 1 can scale the meals for a day such that the total calories is within the range specified by the sum of the daily calorie target selections 216 of each meal participant.

The calorie apportionment selection 217 can specify the meals and proportions by which a meal participant prefers to consume their daily calorie target. In the example of FIG. 2, daily calorie target selection 216 is “1600-1800” and the calorie apportionment selection 217 is “20/20/60.” “20/20/60” can mean that 20% of the daily calories are apportioned to breakfast, 20% of the daily calories are apportioned to lunch, and 60% of the daily calories are apportioned to dinner. In embodiments of the invention, the Generate Meal Plan step 145 of FIG. 1 can include scaling each meal in accordance with the calorie apportionment selection 217. In the example shown in FIG. 2, the Generate Meal Plan step 145 of FIG. 1 can apportion 20% of the daily target “1600-1800” to a breakfast meal (320-360 calories) and a breakfast meal selected in the Generate Meal Plan step 145 of FIG. 1 can be scaled to include 320-360 calories. If there is more than one meal participant, the meal selected by the Generate Meal Plan step 145 of FIG. 1 can be scaled to the sum of the number of calories apportioned to that meal for each meal participant.

The type selection 218 can specify whether the user profile is a regular meal participant or a guest meal participant. Guest meal participants can be denoted in the list of user profiles 200 with a “(G)” adjacent the profile name. In embodiments of the invention, the software can, by default, assign each meal participant having a type 218 “regular” to each meal of each day of the meal plan. In the Enter Meal Level Servings Adjustment 140 of FIG. 1, a user can remove meal participants having a type 218 “regular” from specific meals according to the meal participants scheduling and availability. Similarly, a meal participant having a type 218 “guest” can be manually added to specific meals if, for example, guests will be attending the meal.

User profiles of type 218 “guest” can be specific or generic although the mechanism for specifying each can be the same. In the example of FIG. 2, a specific guest user profile for “Uncle Frank” can be created according to information about Uncle Frank including his allergies and dislikes. A generic guest user profile can be created, for example “Adult Guest”, including common settings for an adult having no allergies, no dislikes, a 2000 calorie diet and a 30/30/40 apportionment. Thus if a user intends to have a guest for a specific meal, but does not know the specific attributes of the guest, the user can add a generic guest profile to the meal at Enter Meal Level Servings Adjustment 140 of FIG. 1, and the Generate Meal Plan step 145 of FIG. 1 can scale the meal according to the generic guest user profile.

The activity level selection 219 can specify an activity level for the meal participant such as light, moderate, or heavy. The activity level selection 219 selection can be used as an alternative to the calorie apportionment selection 217 and the calorie apportionment selection 217 can be omitted. In embodiments that omit the calorie apportionment selection 217, a calorie apportionment can be calculated programmatically based on dietary recommendations for a meal participant of the specified age 211, height 212, weight 213, and activity level selection 219.

Embodiments of the invention include sharing or transmitting a user profile and including a shared guest user profile in the Enter Meal Level Servings Adjustment step 140 of FIG. 1.

FIG. 3 is an exemplary input and display screen for a group profile according to an exemplary embodiment of the invention. As shown in FIG. 3, an exemplary input and display screen for a group profile can include a group name 300, a location identifier 310, a budget 320, and ingredients substitution list 330, and a meal substitution list 340.

The group name 300 can be entered by a user and can be descriptive of the group of user profiles. In the example of FIG. 3, the group name 300 is a surname and the group association identifier “family.” The location identifier 310 can be a zip code. In other embodiments of the invention, the location identifier 310 can be a city name or area code. In still other embodiments of the invention, the location identifier 310 can be determined by the program using location based services such as GPS, IP address geolocation, cellphone tower triangulation, and WiFi access point coordinate cross reference.

The budget 320 can be a selection of a range from a list of options. In other embodiments, the budget 320 can be a free text entry field wherein a user can enter a number representing a budget for the meal plan. The budget 320 can be used in the Generate Meal Plan step 145 of FIG. 1 to constrain the total cost of the meal plan to the budget 320. The budget 320 can be apportioned to each meal. In a meal plan covering two days and six meals, a budget of $50-60 could be apportioned equally between the six meals for a range of $8.30-$10.00 per meal. In another embodiment, the budget can be divided equally between the days in the meal plan, then apportioned between the meals of each day according to the calorie apportionment selection 217 of FIG. 2 for a particular user profile or the average of the calorie apportionment selection 217 for all regular type user profiles. In still further embodiments of the invention, the budget 320 can be divided equally between the days of the meal plan and then apportioned between each meal of the day according to a user-designated apportionment selection (not shown), for example 30/30/40.

The ingredients substation list 330 can be a persistent global user preference. If a dish includes an ingredient on the substitution list 330, the ingredient can be substituted according to the substitution list 330. For example, if the Generate Meal Plan step 145 of FIG. 1 selects a dish of “garden salad” which contains “peas”, the Generate Meal Plan step 145 of FIG. 1 can substitute “black beans” for “peas.” Similarly with the meal substitution list 340, if the Generate Meal Plan step 145 of FIG. 1 selects a dish of “huevos rancheros”, the Generate Meal Plan step 145 of FIG. 1 can substitute “omelets” for “huevos rancheros.”

FIG. 4 is an exemplary input and display screen for a snack budget selection, cuisine selection, and day selection according to an exemplary embodiment of the invention. As shown in FIG. 4, the exemplary input and display screen for a snack budget selection, cuisine selection, and day selection can include a snack budget selection 400, a cuisine selection 410, and a day chooser 420, an edit group profile button 430, an edit user profiles button 440, and a next button 450. The exemplary display screen of FIG. 4 can be a “home screen” and can be a starting point for the method described in conjunction with FIG. 1.

The snack budget selection 400 can be range of dollar values that a user desires to apportion to snack food in addition to the cost of the ingredients for the meal plan. The snack budget selection 400 can be a drop list as shown in FIG. 4, or other suitable input such as a textbox or radio button.

The cuisine selection 410 can be a list of cuisines or themes that the user can select for the meal plan. If, for example, “Mexican” is selected for a cuisine, the Generate Meal Plan step 145 of FIG. 1 can select dishes and meals that have been designated as “Mexican” or “Latin.” If, for example, “30-Mins or less” is selected, the Generate Meal Plan step 145 of FIG. 1 can select dishes and meals that have estimated preparation times less than 30 minutes. If, for example, “Bachelor” is selected for a cuisine, the Generate Meal Plan step 145 of FIG. 1 can select dishes and meals that have an estimated preparation skill-level of easy, call for few ingredients, or call for ingredients with long shelf-life.

The day chooser 420 can be used to select the days to be covered by the meal plan generated in the Generate Meal Plan step 145 of FIG. 1. In the example in FIG. 4, the days of Sep. 10-13, 2014 are selected.

The edit group profile button 430 can be used to access a group profile settings page, for example, the group profile settings shown and described in conjunction with FIG. 3. The edit user profiles button can be used to access a user profiles settings page, for example, the user profile settings shown and described in conjunction with FIG. 2. The next button 450 can be selected to indicate that a user has finalized the selections of snack budget selection 400, a cuisine selection 410, and a day chooser 420.

FIG. 5 is an exemplary input and display screen for a meal plan participants according to an exemplary embodiment of the invention. As shown in FIG. 5, an exemplary input and display screen for a meal plan participants can include the days covered by the meal plan 510, 520, 530, 540, the meal events planned for each day (breakfast, lunch, dinner), and a list of meal participants for each meal. For example, breakfast on Sep. 11, 2014 can include meal participants Rich, Molly, Billy, and Kate while dinner on Sep. 11, 2014 can include only Rich and Molly. The meal participants for each meal can be initially populated with each of the user profiles for users having a type “regular.” Thereafter, regular meal participants can be removed by selecting the [x] next to the meal participants name and guest meal participants can be added by selecting the [+].

The exemplary input and display screen for a meal plan participants can further include a back button 550 and a next button 560. The back button 550 can be selected if a user desires to change a previously entered value, for example, to make changes to user profiles, the group profile, cuisine, budget, or days. When the user is satisfied with the entries, the process of creating a meal plan can proceed to a next step by selecting the next button 560.

FIG. 6 is an exemplary input and display screen for staple and carry-over ingredients according to an exemplary embodiment of the invention. As shown in FIG. 6, an exemplary input and display screen for staple and carry-over ingredients can include a list of staple ingredients and spices 610 and a list of carry-over ingredients 620. The exemplary input and display screen for staple and carry-over ingredients of FIG. 6 can be associated with Confirm-Carry-Over step 143 of FIG. 1 and the Confirm Staples step 150 of FIG. 1. The list of staple ingredients and spices 610 can be displayed in conjunction with the Confirm Staples step 150 of FIG. 1 while the list of carry-over ingredients 620 is hidden. The list of carry-over ingredients 620 can be displayed in conjunction with the Confirm Carry-Over step 143 of FIG. 1 while the list of staple ingredients and spices 610 is hidden.

The list of staple ingredients and spices 610 can include ingredients of dishes in a meal plan that are likely to be in any household or that were purchased for a previous meal plan and are not likely to be exhausted. Staple ingredients and spices can include for example, olive oil, black pepper, salt, flour, etc. User can select “yes” or “no” for each staple ingredient or spice to indicate whether the ingredient is on-hand. If “yes” the ingredient is excluded from the shopping list. For example, if a dish calls for black pepper, the list of staples and spices can include black pepper. If a user has black pepper, “yes” can be selected causing black pepper to be excluded from the shopping list.

Similarly, the list of carry-over ingredients 620 can include ingredients of dishes of the current meal plan that were purchased in a previous meal plan and the previous meal plan did not require use of all of the ingredient. For example, if carrots are sold in 16 oz units and a dish from a previous meal plan included 10 oz of carrots, the remaining 6 oz, if not used in another dish, can be considered carry-over. To minimize wastage, the Generate Meal Plan step 145 of FIG. 1 can select dishes having carrots for the current meal plan to minimize the likelihood of wastage of the extra 6 oz of carrots due to spoilage. The carry-over ingredients 620 each include the option to select “yes” or “no” if the carry over ingredients are still on-hand. If, in the example of the carrots, the carrots are not used and not spoiled, a user can select “yes” and 6 oz of carrots can be removed from the shopping list for the current meal plan. If however the carrots have been used or have spoiled, the user can select “no” and the carrots are included on the shopping list for the meal plan.

FIG. 7 is an exemplary input and display screen for snack food and non-grocery items according to an exemplary embodiment of the invention. As shown in FIG. 7, an exemplary input and display screen for snack food and non-grocery items can include a list of snack food items 710 and a list of non-grocery items 720. A user can select items from the list of snack foods 710 to add to the grocery list. In embodiments of the invention, a user can be prevented from selecting snack food in excess of the budget selected in the Select Snack Budget and Cuisine step 125 of FIG. 1. In embodiments of the invention, a user can be warned from selecting snack food in excess of the budget selected in the Select Snack Budget and Cuisine step 125 of FIG. 1. The warning can be, for example, a message in a pop-up window, a change in the color of a graphical element, or a toast-style message. A user can further select from a list of non-grocery items 720 that the user desires to add to the shopping list.

FIG. 8A and FIG. 8B are exemplary input and display screens for a meal plan according to an exemplary embodiment of the invention. As shown in FIG. 8A and FIG. 8B, exemplary input and display screens for a meal plan 800a and 800b includes a list of days and meals 810a, 811a, 812a, 813a and 810b, 811b, 812b, 813b, a dish selection menu 820a and 820b, a dish ingredients list 830a and 830b, dish preparation instructions 840a and 840b, and a current prices list 850a and 850b, a back button 860a and 860b, and a next button 870a and 870b.

The list of days and meals 810a, 811a, 812a, 813a and 810b, 81 b. 812b, 813b can include the dishes selected in the Generate Meal Plan step 145 of FIG. 1. Each meal, (e.g. break, lunch, or dinner) can include one or more dishes that are planned for that meal. Because the dishes are selected by the Generate Meal Plan step 145 of FIG. 1, it is possible that some meals may be unappealing to meal participants or the person preparing the meal. Thus, embodiments of the invention contemplate substitution of one dish for another dish and one ingredient for another ingredient.

In the example of FIG. 8A and FIG. 8B, a particular dish can be selected, such as the “vegetable medley” planned for dinner on Sep. 13, 2014. Upon selection, details of the dish can be displayed in the dish selection menu 820a and 820b, dish ingredients list 830a and 830b, dish preparation instructions 840a and 840b. The dish can be substituted for another dish by selecting a second dish from the dish selection menu 820a and 820b. In the example of FIG. 8A and FIG. 8B, the dish selection menu 820a and 820b is embodied as a drop list however, other common methods of selecting an item from a plurality of options is contemplated. Upon selection of a substitute dish, the user can be prompted whether this substitution should be retained as a persistent preference such that “vegetable medley” is always replaced with the substitute dish. The persistent preference can be editable through the group preferences interface described in conjunction with FIG. 3.

Ingredients of the selected dish can be added, removed, or substituted in dish ingredients list 830a and 830b according to user preference. For example, if a meal participant does not prefer peas, a user can select the [x] next to peas to remove peas from the dish “vegetable medley.” Upon removal, a user can be prompted (not shown) if they would like to select a substitute ingredient and be presented with the option to select a substitute ingredient. Upon selection of a substitute ingredient, the user can be prompted whether this substitution should be retained as a persistent preference such that peas are replaced with the substitute ingredient in all dishes. The persistent preference can be editable through the group preferences interface described in conjunction with FIG. 3.

Instructions for preparing the dish can be displayed in the dish preparation instructions 840a and 840b. The cost for the meal plan (before substitutions) can be displayed in the current prices list 850a and 850b. The current prices list 850a and 850b can be static and not updated after substitutions. The current prices list 850a and 850b can be dynamically updated such that an updated price is displayed after each substitution. The current prices list 850a and 850b can display the cost to purchase the ingredients to prepare each of the dishes in the meal plan. The current prices list 850a and 850b can display the cost to purchase the ingredients to prepare each of the dishes in the meal plan while excluding the cost of on-hand staple and carry-over ingredients. The current prices list 850a and 850b can further include the cost of snack food and non-grocery items.

The back button 860a and 860b can be selected to revert the previous input screen. The next button 870a and 870b can be selected to indicate that no further changes are to be made to the meal plan and to advance the process to the Recalculate and Display Cost step 175 of FIG. 1 and the Select Grocery Provider and Confirm Step 180 of FIG. 1.

FIG. 9 is an exemplary input and display screen for a grocery provider according to an exemplary embodiment of the invention. As shown in FIG. 9, the exemplary input and display screen for a grocery provider can include a list of grocers 910, 911, 912, and 913 and a list of prices 920, 921, 922, and 923. The prices 920, 921, 922, and 923 can represent the cost to purchase the ingredients of the meal plan in view of any substitutions less staples and carry-over. The prices 920, 921, 922, and 923 can further include the cost of snack food and non-grocery items. The exemplary display screen of FIG. 9 can facilitate the Recalculate and Display Cost step 175 of FIG. 1 and the Select Grocery Provider and Confirm Step 180 of FIG. 1. A user can select a grocery provider. In the example of FIG. 9, the selected grocery provider can be “Giant Food.” Selecting the back button 930 can revert the program to the previous input screen, for example the meal plan display and substitution screen of FIG. 8A and FIG. 8B. Selecting the confirm button 940 can indicate that the user does not want to make any additional changes and would like to finalize the meal plan. Upon selecting the confirm button 940, the program can provide further selections to show the shopping list, show the meal plan, or send the shopping list to electronic fulfillment.

FIG. 10 is an exemplary results and display screen for a completed meal plan according to an exemplary embodiment of the invention. As shown in FIG. 10, an exemplary results and display screen for a completed meal plan can include the selected grocer and price 1000, a show shopping list button 1010, a show meal plan button 1020, and an electronic fulfillment button 1030. The selected grocer and price 1000 can display the grocery store selected and the cost to purchase the shopping list at the selected grocer. Selecting the show shopping list button 1010 can cause the shopping list to be displayed (not shown) including the list of ingredients included in the dishes, snack food, and non-grocery items. The shopping list can be sent to an email recipient or posted to social media.

Selecting the show meal plan button 1020 can display the meal plan in substantially similar form to FIG. 8A or FIG. 8B provided, however, that changes to the meal plan can be restricted or disabled after the meal plan and grocery provider has been confirmed. The finalized meal plan can further include a rating selection (not shown) for each meal or each dish. The rating can be entered by a user of the program. The rating can be stored and used in generating subsequent meal plans such that dishes and meals that that received high ratings are weighted to be selected more frequently in the Generate Meal Plan step 145 of FIG. 1 and thus displayed more frequently in the Display Meal Plan and Cost step 160 of FIG. 1. Dishes and meals that receive a low rating can be weighted to be selected less frequently in the Generate Meal Plan step 145 of FIG. 1. Selecting the electronic fulfillment button 1030 can cause the shopping list to be sent to a grocery fulfillment provider such as Giant's Peapod or similar services from other grocers.

It will be apparent to those skilled in the art that various modifications and variations can be made in the method for generating low-waste personalized meal plans within a budget without departing from the spirit or scope of the invention. Thus, it is intended that embodiments of the invention cover the modifications and variations of this invention provided they come within the scope of the appended claims and their equivalents.

What is claimed is:

1. A method for generating a meal plan, the method comprising:
receiving a plurality of user profiles;
receiving a cuisine selection;
receiving a budget selection;
displaying a meal plan in accordance with the cuisine selection and the budget selection, the meal plan including a plurality of meals wherein at least one of the plurality of meals is scaled in accordance with the plurality of user profiles;
displaying a first cost associated with the meal plan;
displaying a shopping list in accordance with the meal plan, the shopping list including a plurality of ingredients associated with the plurality of meals.

2. The method of claim 1 wherein each of the plurality of user profiles includes a daily caloric intake selection.

3. The method of claim 2 further comprising:
apportioning the daily caloric intake selection between at least three meals.

4. The method of claim 1 wherein each of the plurality of user profiles includes an activity level selection.

5. The method of claim 1 further comprising:
receiving a location information.

6. The method of claim 5 wherein the location information is a zip code.

7. The method of claim 5 further comprising:
sending the shopping list to a grocery provider.

8. The method of claim 1 wherein the first cost associated with the meal plan is based on a price of the plurality of ingredients at a first grocery store.

9. The method of claim 8 further comprising:
displaying a second cost associated with the meal plan;

10. The method of claim 9 wherein the first cost associated with the meal plan is based on a first price of the plurality of ingredients at a first grocery store and the second cost associated with the meal plan is based on a second price of the plurality of ingredients at a second grocery store.

11. The method of claim 1 further comprising:
receiving a snack food budget;
providing a list of snack food;
receiving a plurality of snack food selections;
adding the plurality of snack food selections to the shopping list.

12. The method of claim 11 further comprising:
indicating when a total cost of the plurality of snack food selections exceeds the snack food budget.

13. The method of claim 1 further comprising:
displaying a first dish of a first meal of the plurality of meals; and
displaying a list of ingredients in the first dish.

14. The method of claim 13 further comprising:
substituting a second dish in place of the first dish; and
updating the shopping list.

15. The method of claim 14 further comprising:
storing the substitution of the second dish in place of the first dish as a persistent preference; and
substituting the second dish in place of the first dish in each of the plurality of meals, respectively.

16. The method of claim 13 further comprising:
substituting a first ingredient on the list of ingredients in the first dish with a second ingredient; and
updating the shopping list.

17. The method of claim 16 further comprising:
storing the substitution of the second ingredient in place of the first ingredient as a persistent preference; and
substituting the second ingredient in place of the first ingredient in each dish of each of the plurality of meals, respectively.

18. The method of claim 13 further comprising:
removing a first ingredient from the list of ingredients in the first recipe; and
updating the shopping list.

19. The method of claim 1 further comprising:
receiving a list of prohibited ingredients;
filtering the plurality of meals to exclude a meal having an ingredient on the list of prohibited ingredients.

20. The method of claim 1 further comprising:
displaying a list of staple ingredients;
receiving a selection of on-hand staple ingredients;
removing the selected on-hand staple ingredients from the shopping list.

21. The method of claim 1 further comprising:
displaying an on-hand quantity for a first ingredient of the plurality of ingredients;
updating the shopping list in accordance with the on-hand quantity;
updating the on-hand quantity.

22. The method of claim 1 further comprising:
receiving a rating for at least one of the plurality of meals;
wherein the displaying of the meal plan is further in accordance with the rating.

23. A method for generating a meal plan, the method comprising:
receiving a plurality of user profiles, each of the plurality of user profiles including a meal participant name and a daily caloric intake selection;
receiving a cuisine selection;
receiving a location information;
receiving a budget selection;
displaying a meal plan in accordance with the cuisine selection and the budget selection, the meal plan including a plurality of meals wherein at least one of the plurality of meals is scaled in accordance with the plurality of user profiles;
displaying a first cost associated with the meal plan, the first cost based on a price a plurality of ingredients associated with the plurality of meals at a first grocery store;
displaying a shopping list in accordance with the meal plan, the shopping list including the plurality of ingredients associated with the plurality of meals.

24. The method of claim 23 further comprising:
displaying a second cost associated with the meal plan;

25. The method of claim 23 further comprising:
receiving a snack food budget;
providing a list of snack food;
receiving a plurality of snack food selections;
adding the plurality of snack food selections to the shopping list.

26. A method for generating a meal plan, the method comprising:
receiving a plurality of user profiles, each of the plurality of user profiles including a meal participant name, a daily caloric intake selection, an activity level selection, and a list of allergens;
receiving a cuisine selection;
receiving a zip code;
receiving a budget selection;
receiving a selection of one or more days;
assigning one or more user profiles of the plurality of user profiles to each of a breakfast meal, a lunch meal, and a dinner meal on each of the one or more days;
displaying a meal plan for the one or more days, the meal plan displayed in accordance with the cuisine selection and the budget selection and scaled in accordance with the one or more user profiles assigned to the breakfast meal, the lunch meal, and the dinner meal on each of the one or more days;
displaying a first cost associated with the meal plan, the first cost based on a price a plurality of ingredients associated with the plurality of meals at a first grocery store;
displaying a shopping list in accordance with the meal plan, the shopping list including the plurality of ingredients associated with the plurality of meals; and
receiving a rating for at least one dish of one of the plurality of meals.
